(19) United States
(12) Patent Application Publication
(10) Pub. No.: US 2016/0069534 A1
(43) Pub. Date: Mar. 10, 2016

(54) LENS HAVING THROUGH HOLE AND LIGHTING MODULE

(71) Applicant: LEXTAR ELECTRONICS CORPORATION, Hsinchu (TW)

(72) Inventor: Chun-Kuang Chen, Hsinchu City (TW)

(21) Appl. No.: 14/945,362

(22) Filed: Nov. 18, 2015

(30) Foreign Application Priority Data
Aug. 17, 2015 (TW) 104126672

(51) Int. Cl. F21V 7/09; F21K 99/00

(52) U.S. Cl. CPC F21V 7/09; F21K 9/54; F21Y 2101/02

(57) ABSTRACT

A lens having a through hole includes a ring portion and at least three reflection portions. The ring portion has an inner wall. The reflection portions are annularly arranged at the inner wall of the ring portion and forming a through hole.

### CROSS-REFERENCE TO RELATED APPLICATIONS

This application claims priority of Taiwan Patent Application No. 104126672 filed on Aug. 17, 2015, the entirety of which is incorporated by reference herein.

### BACKGROUND OF THE INVENTION

1. Field of the Invention

The present disclosure relates to a lens, and in particular to a lens having a through hole.

2. Description of the Related Art

Thanks to advances in electronic technology, light-emitting diodes (LEDs) have the advantages of high luminance, small size, low power consumption, and long life time, and are thus widely used in various lighting fixtures and displays.

However, these light-emitting diodes have the disadvantage of a small illumination angle, causing illumination inefficiency. Therefore, in the prior art, lenses are utilized for increasing the illumination angle of light-emitting diodes. Although conventional lenses have been generally adequate for their intended purposes, they have not been entirely satisfactory in all respects, and need to be enhanced and improved.

### BRIEF SUMMARY OF THE INVENTION

The present invention provides a lens having a through hole, and a lighting module. The manufacturing cost of the lens and the lighting module is low, and the extraction efficiency of the lighting module is increased.

The present invention provides a lens having a through hole including a ring portion and at least three reflection portions. The ring portion includes an inner wall. The reflection portions are annularly arranged on the inner wall of the ring portion and form a through hole.

The present invention provides a lighting module including the lens. The lighting module further includes a substrate and a lighting element. The substrate includes a supporting surface. The ring portion and the reflection portions of the lens are disposed on the supporting surface. The lighting element is disposed on the supporting surface. The lighting element is located in the through hole, and surrounded by the reflection portions.

The present invention provides a lens having a through hole including a ring portion and at least three reflection portions. The ring portion includes an inner wall. The reflection portions are annularly arranged at the inner wall of the ring portion and form a through hole. Each of the reflection portions includes a first curved surface, a second curved surface opposite to the first curved surface, and a protrusion end connected to the first curved surface and the second curved surface. The protrusion ends are arranged around the through hole, and the distance between the first curved surface and the second curved surface is gradually increased from the protrusion end to a located far from the protrusion end.

The present invention provides a lighting module including a lens. The lighting module further includes a substrate and a lighting element. The substrate includes a supporting surface. The ring portion and the reflection portions of the lens are disposed on the supporting surface. The lighting element is disposed on a supporting surface, and located in the through hole, and surrounded by the reflection portions.

In conclusion, because of the through hole of the lens and the lighting module of the present disclosure, the light beam emitted by the top surface of the lighting element directly passes through the lens via the through hole. Therefore, the luminance of the lighting module is improved, and the material cost of the lens is reduced by the through hole. Moreover, Due to the structures of the ring portion and the reflection portion, the utilization of the light beam emitted from the side surface of the lighting element is increased, and the extraction efficiency of the lighting module is increased.

### BRIEF DESCRIPTION OF THE DRAWINGS

The invention can be more fully understood by reading the subsequent detailed description and examples with references made to the accompanying drawings, wherein:

FIG. 1 is a schematic view of a lighting module 1 in accordance with a first embodiment of the present disclosure.

FIG. 2 is a top view of the lighting module 1 in accordance with the first embodiment of the present disclosure.

FIG. 3 is a cross-sectional view along the line AA of FIG. 2.

FIG. 4 is a top view of a lighting module 1 in accordance with a second embodiment of the present disclosure.

FIG. 5 is a top view of a lighting module 1 in accordance with a third embodiment of the present disclosure.

FIG. 6 is a top view of a lighting module 1 in accordance with a fourth embodiment of the present disclosure.

FIG. 7 is a top view of a lighting module 1 in accordance with a fifth embodiment of the present disclosure.

FIG. 8 is a top view of a lighting module 1 in accordance with a sixth embodiment of the present disclosure.

FIG. 9 is a top view of a lighting module 1 in accordance with a seventh embodiment of the present disclosure.

FIG. 10 is a cross-sectional view along the line BB of FIG. 9.

### DETAILED DESCRIPTION OF THE INVENTION

The following disclosure provides many different embodiments, or examples, for implementing different features of the present disclosure. Specific examples of components and arrangements are described below to simplify the present disclosure.

In addition, the present disclosure may repeat reference numerals and/or letters in the various examples. This repetition is for the purpose of simplicity and clarity and does not in itself dictate a relationship between the various embodiments and/or configurations discussed. Furthermore, the shape, size, and thickness in the drawings may not be drawn to scale or simplified for clarity of discussion; rather, these drawings are merely intended for illustration.

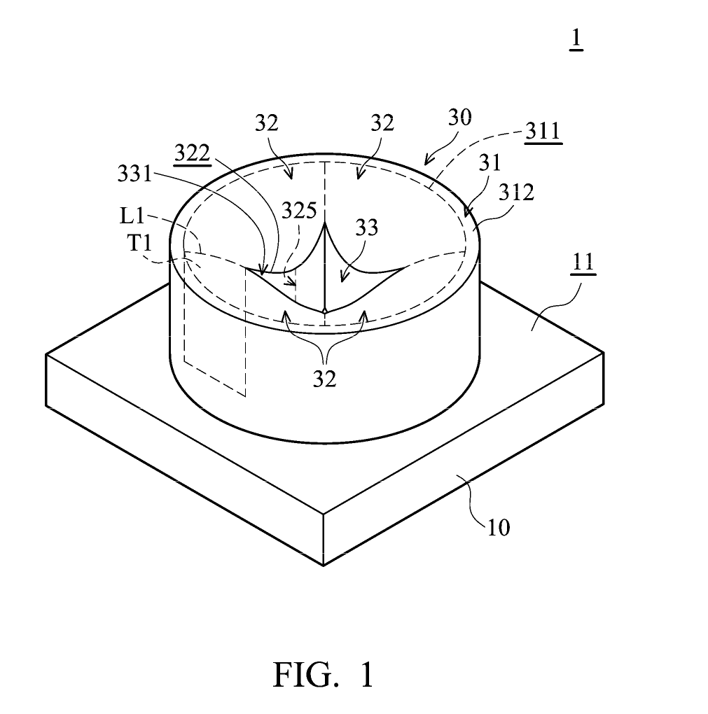

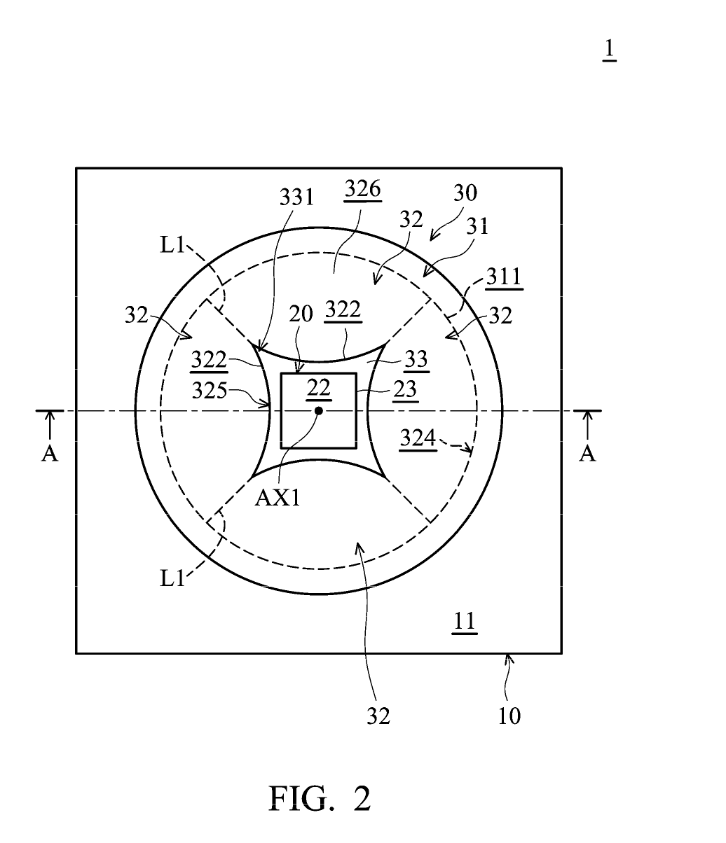

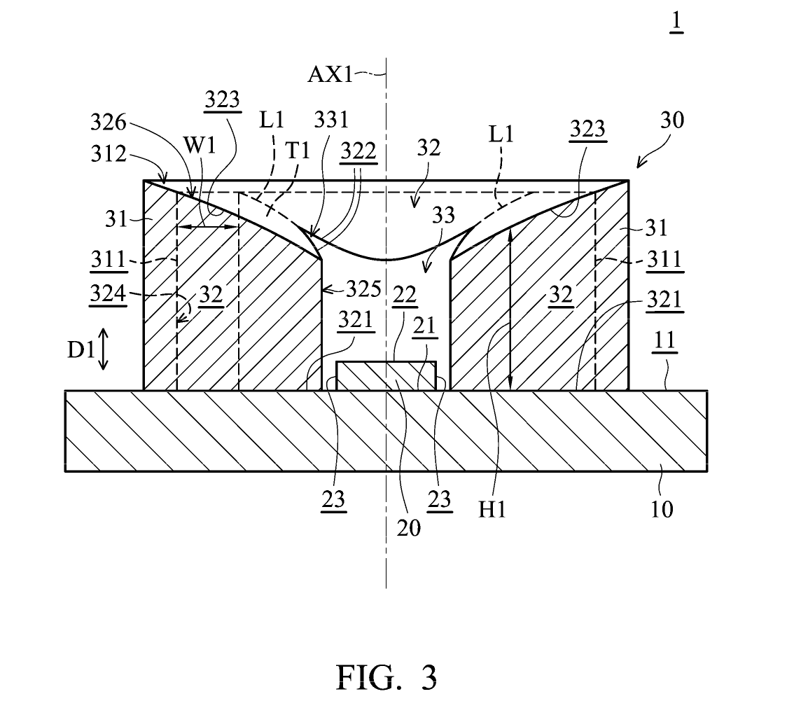

FIG. 1 is a schematic view of a lighting module 1 in accordance with a first embodiment of the present disclosure. FIG. 2 is a top view of the lighting module 1 in accordance with the first embodiment of the present disclosure. FIG. 3 is a cross-sectional view along the line AA of FIG. 2. In this embodiment, the lighting module 1 is a direct LED backlight module applied to a display. The lighting module 1 includes a substrate 10, a lighting element 20 and a lens 30. The substrate 10 includes a supporting surface 11, and the lighting element 20 and the lens 30 are disposed on supporting surface 11.

The lighting element 20 is configured to emit light beams. The lighting element 20 is a light-emitting diode (LED) located in the lens 30. In some embodiments, the lighting module 1 includes lighting elements 20 and lenses 30. The lighting elements 20 and lenses 30 are arranged in an array on the substrate 10.

The lens 30 is configured to change the transmitting patch of the light beam generated by the lighting module 1. The lens 30 is made from transparent materials, such as glass, Poly methyl Methacrylate (PMMA) or Polycarbonate (PC). The lens 30 includes a ring portion 31 and at least three reflection portions 32. In some embodiments, the ring portion 31 and the reflection portions 32 are formed as a single piece, and made of the same material. The ring portion 31 and the reflection portions 32 are disposed on the supporting surface 11 of the substrate 10.

The ring portion 31 is a ring-like hollow structure and is extended along a vertical direction D1. The vertical direction D1 is perpendicular to the supporting surface 11. In this embodiment, the ring portion 31 includes a central axis AX1 extended along the vertical direction D1. The ring portion 31 includes an inner wall 311 around the central axis AX1, and perpendicular to the supporting surface 11.

The reflection portions 32 are annularly arranged at the inner wall 311 of the ring portion 31, and the reflection portions 32 form a through hole 33. In other words, the reflection portions 32 are around the central axis AX1, and arranged in a radial manner.

The lighting element 20 is located in the through hole 33, and surrounded by the reflection portions 32. The center of the lighting element 20 is located at the central axis AX1. The lighting element 20 includes a rear surface 21, a top surface 22, and side surfaces 23. The rear surface 21 is connected to the supporting surface 11 of the substrate 10. The top surface 22 is opposite to the rear surface 21. The side surface 23 faces the light-entering surface 322 of the reflection portion 32 of the lens 30. The top surface 22 is not covered by the reflection portion 32 in a vertical direction D1 perpendicular to the supporting surface 11.

Each of the reflection portions 32 includes a bottom surface 321, a light-entering surface 322, a light-exiting surface 323, a connection surface 324, a protrusion end 325, and a top end 326. The bottom surface 321 is in contact with and parallel to the supporting surface 11. The light-entering surface 322 extends along the vertical direction D1 and is perpendicular to the bottom surface 321. In this embodiment, the light-entering surface 322 is a curved surface. A gap 331 is formed between two adjacent light-entering surfaces 32 of the reflection portions 32. In a cross section perpendicular to the vertical direction D1 of the lens 30, the gap 331 is substantially a triangle, and two adjacent light-entering surfaces 322 of the reflection portions 32 are in a V shape.

The light-exiting surface 323 is opposite to the bottom surface 321, and the light-exiting surface 323 is inclined relative to the bottom surface 321. In this embodiment, the light-exiting surface 323 is a curved surface. The distance W1 between the curved surface 323 and the inner wall 311 is gradually decreased relative to inner wall 311. Moreover, the distance W1 is gradually decreased from the bottom surface 321 to a location far from the bottom surface 321. The distance W1 is measured along a direction parallel to the bottom surface 321.

The height H1 between the curved surface 323 and the bottom surface 321 is gradually decreased from the inner wall 311 to a location far from the inner wall 311. In other words, the height H1 of the lens 30 is gradually decreased from the ring portion 31 to the protrusion end 325 relative to the supporting surface 11. The height H1 is measured along the vertical direction D1.

Two adjacent curved surfaces 323 of the reflection portions 32 are connected via a connection line L1. Two adjacent reflection portions 32 are connected via a connection interface T1, and the connection interface T1 is connected to the inner wall 311. Moreover, the connection surface 324 is in contact with the inner wall 311.

In this embodiment, the protrusion end 325 is located at the light-entering surface 322, and substantially extends along the vertical direction D1. The protrusion ends 325 are far from the inner wall 311, and connected to the light-exiting surface 323. The protrusion ends 325 are around the through hole 33. The protrusion ends 325 are close to the central axis AX1 of the lighting element 20. In other words, the distance between the protrusion end 325 and the central axis AX1 is a shortest distance between the lens 30 and the central axis AX1.

In this embodiment, the distance between the protrusion end 325 and the central axis AX1 is substantially equal to the distance between the light-entering surface 322 and the central axis AX1. Moreover, the top end 326 is connected to a top portion 312 of the ring portion 31.

In this embodiment, the lighting element 20 can emit light beams via the side surface 23. Because of the structure of the lens 30, the light beam emitted from the top surface 22 (and side surface 23) of the lighting element 20 can directly pass through the lens 30 via the through hole 33 and the gap 331 of the through hole 33, or can be reflected by the light-entering surface 322. Therefore, the loss of the light beam generated by the lighting element 20 is decreased, and the luminance of the lighting module 1 is increased. Moreover, the material cost of the lens 30 is reduced by the through hole 33 and the gap 331 of the through hole 33.

In addition, the light beam emitted from the side surface 23 (and the top surface 22) of the lighting element 20 enters into the reflection portion 32 via the light-entering surface 322, and exits the reflection portion 32 via the light-exiting surface 323. Therefore, because of the structures of the ring portion 31 and the reflection portion 32, the utilization of the light beam emitted from the side surface 23 of the lighting element 20 is increased, and the extraction efficiency of the lighting module 1 is increased.

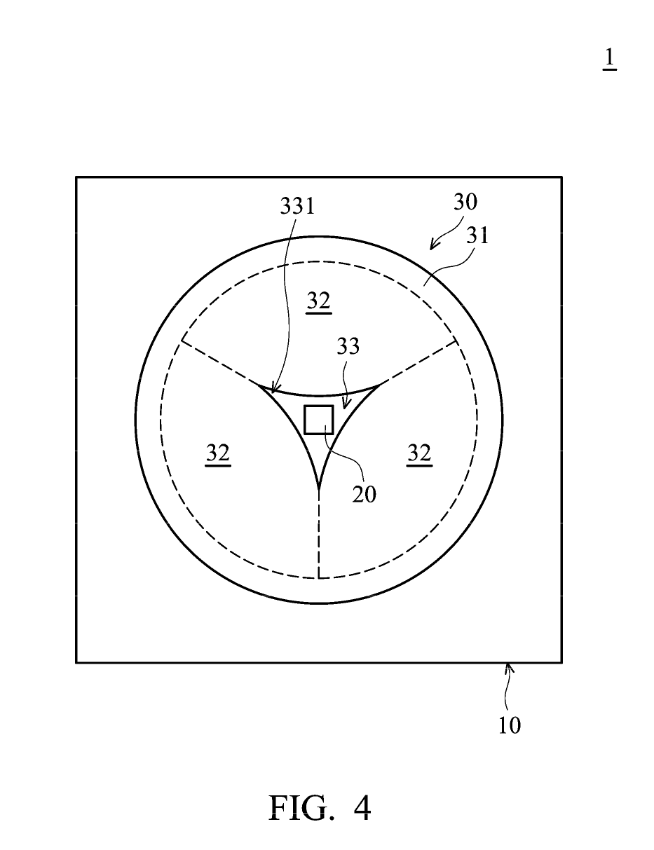

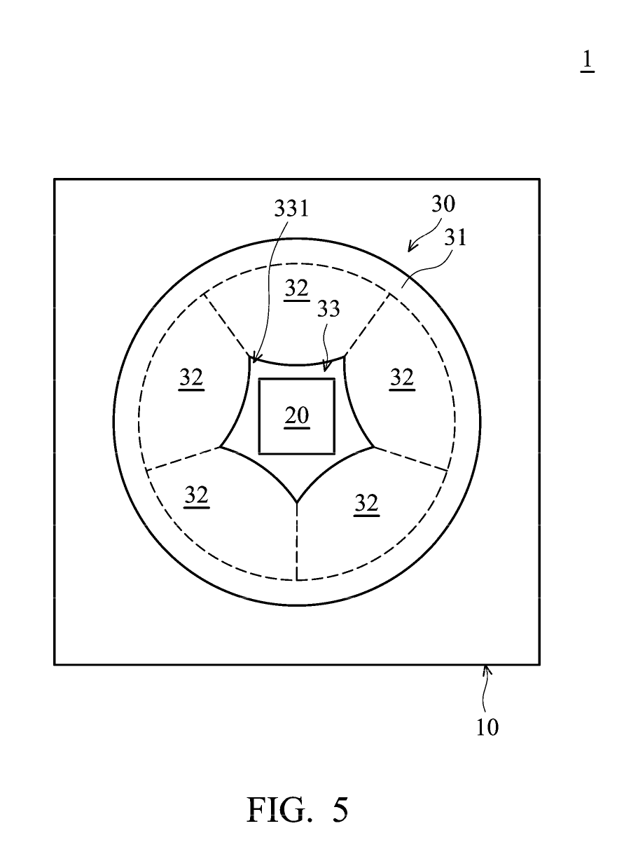

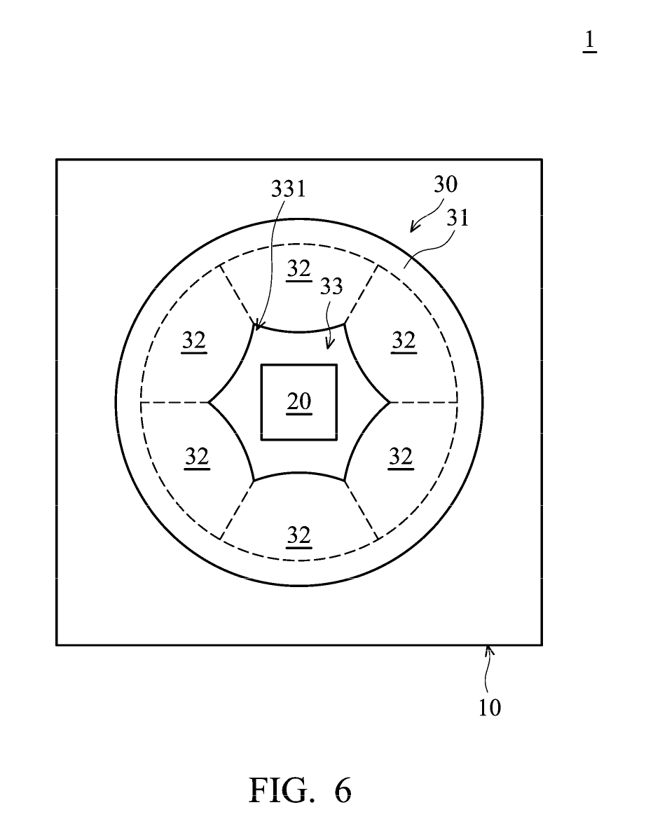

FIG. 4 is a top view of a lighting module 1 in accordance with a second embodiment of the present disclosure. As shown in FIG. 4, there are three reflection portions 32. FIG. 5 is a top view of a lighting module 1 in accordance with a third embodiment of the present disclosure. As shown in FIG. 5, there are five reflection portions 32. FIG. 6 is a top view of a lighting module 1 in accordance with a fourth embodiment of the present disclosure. As shown in FIG. 6, there are six reflection portions 32.

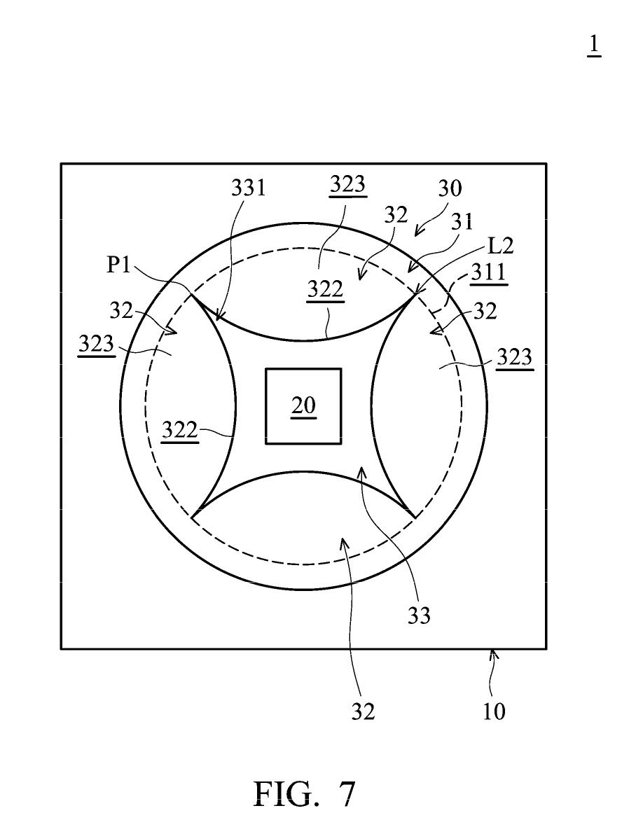

FIG. 7 is a top view of a lighting module 1 in accordance with a fifth embodiment of the present disclosure. Two adjacent curved surfaces 323 of the reflection portion 32 are connected via a connection point P1. Two adjacent reflection portions 32 are connected via a boundary line L2, and the boundary line L2 is adjacent to the inner wall 311. Therefore, the size of the through hole 33 can be increased, and the material utilized by the lens 30 can be reduced.

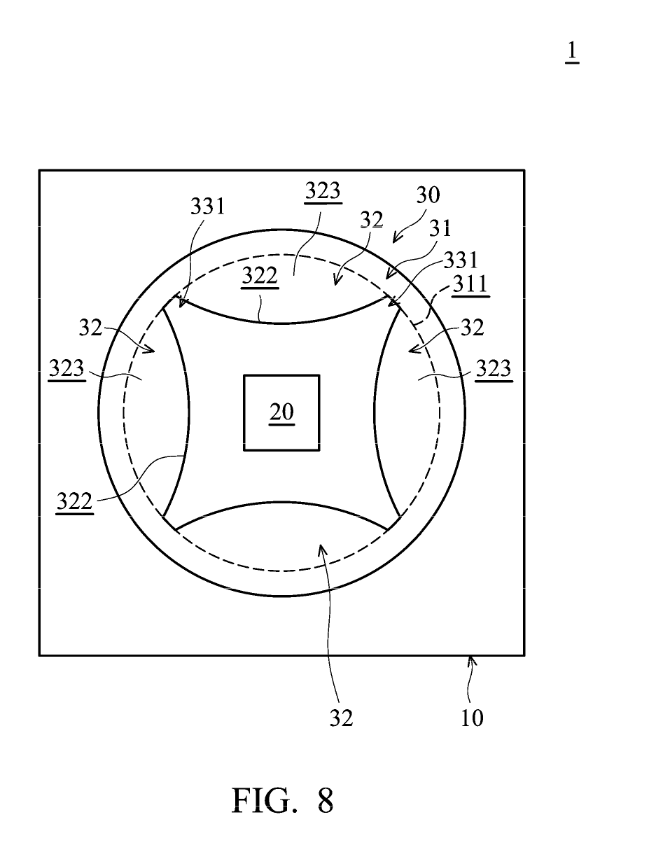

FIG. 8 is a top view of a lighting module 1 in accordance with a sixth embodiment of the present disclosure. A gap 331 is located between two adjacent curved surfaces 323 of the reflection portions 32. In other words, the gap 331 is connected to the inner wall 311. Therefore, the size of the through hole 33 can be increased further, and the material of the lens 30 can be reduced.

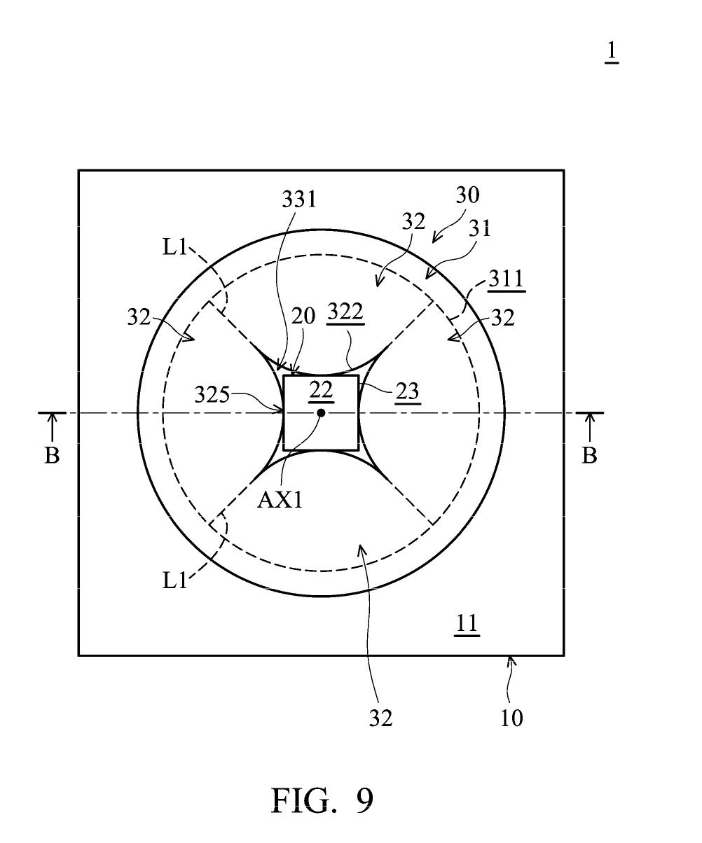

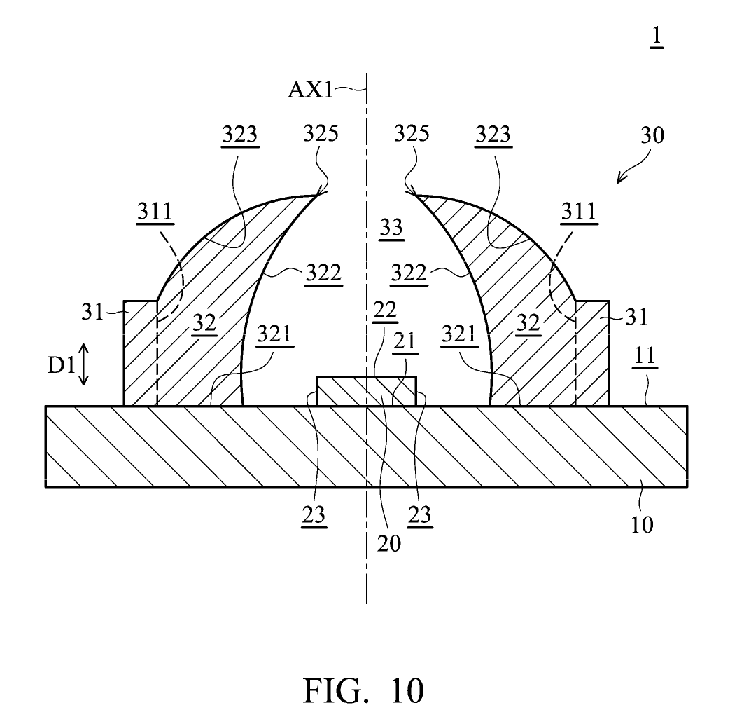

FIG. 9 is a top view of a lighting module 1 in accordance with a seventh embodiment of the present disclosure. FIG. 10 is a cross-sectional view along the line BB of FIG. 9. The reflection portions 32 includes curved surfaces 323 (light-exiting surfaces 323), curved surfaces 322 (light-entering surfaces 322) opposite to curved surfaces 323, and protrusion ends 325 connected to curved surfaces 322 and 323. The reflection portions 32 are arranged in a radial manner about the central axis AX1. The curved surface 322 and/or the curved surface 323 is gradually far away the central axis AX1 from the protrusion end 325 to the bottom surface 321.

The protrusion ends 325 are around the through hole 33, and the distance between the curved surface 323 and the curved surface 322 is gradually increased from the protrusion end 325 to a location far from the protrusion end 325. The distance between the protrusion end 325 and the central axis AX1 is a shortest distance between the lens 30 and the central axis AX1.

The top surface 22 of the lighting element 20 is not covered by the protrusion ends 325 of the reflection portion 32 in the vertical direction D1 perpendicular to supporting surface 11. In another embodiment, the top surface 22 of the lighting element 20 can be covered by the protrusion ends 325 of the reflection portion 32 in the vertical direction D1. In other words, the protrusion end 325 is located over the top surface 22 in the vertical direction D1. Therefore, the luminance of the lateral side of the lighting module 1 is increased.

In conclusion, because of the through hole of the lens and the lighting module of the present disclosure, the light beam emitted by the top surface of the lighting element directly passes through the lens via the through hole. Therefore, the luminance of the lighting module is improved, and the material cost of the lens is reduced by the through hole. Moreover, due to the structures of the ring portion and the reflection portion, the utilization of the light beam emitted from the side surface of the lighting element is increased, and the extraction efficiency of the lighting module is increased.

The disclosed features may be combined, modified, or replaced in any suitable manner in one or more disclosed embodiments, but are not limited to any particular embodiments.

While the invention has been described by way of example and in terms of preferred embodiment, it is to be understood that the invention is not limited thereto. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A lens having a through hole, comprising:
a ring portion comprising an inner wall; and
at least three reflection portions annularly arranged at the inner wall of the ring portion and forming a through hole.

2. The lens as claimed in claim 1, wherein each of the reflection portions comprises a bottom surface and a curved surface, a distance between the curved surfaces and the inner wall is gradually decreased, from the bottom surface to a location far from the bottom surface, relative to the inner wall.

3. The lens as claimed in claim 2, wherein two of the curved surfaces of the reflection portions are adjacent to each other, and a gap is formed between the two of the curved surfaces.

4. The lens as claimed in claim 2, wherein two adjacent curved surfaces of the reflection portions are connected via a connection point.

5. The lens as claimed in claim 2, wherein two adjacent curved surfaces of the reflection portions are connected via a connection line.

6. The lens as claimed in claim 5, wherein two adjacent reflection portions are connected via a boundary line, and the boundary line is adjacent to the inner wall.

7. The lens as claimed in claim 5, wherein two adjacent reflection portions are connected via connection interface, and the connection interface is connected to the inner wall.

8. The lens as claimed in claim 1, wherein each of the reflection portions comprises a top end connected to a top portion of the ring portion.

9. The lens as claimed in claim 1, wherein each of the reflection portions comprises a light-exiting surface and a protrusion end far from the inner wall and connected to the light-exiting surface, wherein the light-exiting surface is a curved surface, and the protrusion ends are around the through hole.

10. A lighting module, comprising the lens as claimed in claim 1, further comprising:
a substrate comprising a supporting surface, wherein the ring portion and the reflection portions of the lens are disposed on the supporting surface; and
a lighting element, disposed on the supporting surface, located in the through hole, and surrounded by the reflection portions.

11. The lighting module as claimed in claim 10, wherein the lighting element comprises a rear surface connected to the substrate, a top surface opposite to the rear surface, and a side surface facing the lens, wherein the top surface is not covered by the reflection portions in a vertical direction perpendicular to the supporting surface.

12. The lighting module as claimed in claim 10, wherein each of the reflection portions comprises a protrusion end adjacent to a central axis of the lighting element, wherein the central axis is perpendicular to the supporting surface, and a distance between the protrusion end and the central axis is a shortest distance between the lens and the central axis.

13. A lens having a through hole, comprising:
a ring portion comprising an inner wall; and
at least three reflection portions annularly arranged at the inner wall of the ring portion, and the reflection portions form a through hole, wherein each of the reflection portions comprises a first curved surface, a second curved surface opposite to the first curved surface, and a protrusion end connected to the first curved surface and the second curved surface,
wherein the protrusion ends are arranged around the through hole, and a distance between the first curved surface and the second curved surface is gradually increased from the protrusion end to a located far from the protrusion end.

14. The lens as claimed in claim 13, wherein two of the curved surfaces of the reflection portions are adjacent to each other, and a gap is formed between the two of the curved surfaces.

15. The lens as claimed in claim 13, wherein two adjacent first curved surfaces of the reflection portions are connected via a connection point.

16. The lens as claimed in claim 13, wherein two adjacent first curved surfaces of the reflection portions are connected via a connection line.

17. The lens as claimed in claim 16, wherein two adjacent reflection portions are connected via a boundary line, and the boundary line is connected to the inner wall.

18. The lens as claimed in claim 16, wherein two adjacent reflection portions are connected via a connection interface, and the connection interface is connected to the inner wall.

19. The lens as claimed in claim 13, wherein the reflection portions are arranged in a radial manner about a central axis, wherein a distance between the protrusion end and the central axis is a shortest distance between the lens and the central axis.

20. The lens as claimed in claim 19, wherein the first curved surface is far away the central axis from the protrusion end to the bottom surface.

21. A lighting module, comprising the lens as claimed in claim 13, further comprising:
a substrate comprising a supporting surface, wherein the ring portion and the reflection portions of the lens are disposed on the supporting surface; and
a lighting element, disposed on the supporting surface, located in the through hole and surrounded by the reflection portions.

22. The lighting module as claimed in claim 21, wherein the lighting element comprises a rear surface connected to the substrate, a top surface opposite to the rear surface, and a side surface facing the lens, wherein the top surface is not covered by the reflection portions in a vertical direction perpendicular to the supporting surface.

23. The lighting module as claimed in claim 21, wherein each of the reflection portions comprises a protrusion end, a central axis adjacent to the lighting element, wherein the central axis is perpendicular to the supporting surface, wherein a distance between the protrusion end and the central axis is a shortest distance between the lens and the central axis.
